(19) United States
(12) Patent Application Publication
(10) Pub. No.: US 2019/0109331 A1
(43) Pub. Date: Apr. 11, 2019

(54) FUEL CELL SYSTEM WITH IMPROVED VENTILATION

(71) Applicant: GM GLOBAL TECHNOLOGY OPERATIONS LLC, Detroit, MI (US)

(72) Inventor: Glenn W. Skala, Churchville, NY (US)

(21) Appl. No.: 15/727,946

(22) Filed: Oct. 9, 2017

(51) Int. Cl. H01M 8/02; H01M 8/04746; H01M 8/04111; H01M 8/0444

(52) U.S. Cl. CPC H01M 8/02; H01M 8/04447; H01M 8/04111; H01M 8/04753

(57) ABSTRACT

The present disclosure provides a fuel cell system which includes a fuel cell stack disposed within an enclosure, a compressor, an inlet air filter, an inlet passageway connecting the inlet air filter to an inlet of the compressor, a flow restrictor and a hydrogen sensor disposed along a ventilation line running from the enclosure back to the inlet passageway. The compressor further includes a compressor outlet in fluid communication with the fuel cell stack and a compressor inlet in fluid communication with the inlet air filter. The compressor may be configured to draw an ambient air stream through the inlet air filter towards the fuel cell stack thereby creating a vacuum in the inlet passageway. The flow restrictor is configured to couple the inlet passageway to the ventilation line running from the enclosure to the inlet passageway.

### TECHNICAL FIELD

The invention relates to an improved fuel cell system having an active ventilation subsystem with accurate leak sensing capabilities via a more robust structure at a lower cost.

### BACKGROUND

Fuel cell systems are increasingly being used as a power source in a wide variety of applications. Fuel cell systems have been proposed for use in power consumers such as vehicles as a replacement for internal combustion engines, for example. Fuel cells may also be used as stationary electric power plants in buildings and residences, as portable power in video cameras, computers, and the like.

Fuel cells are electrochemical devices which combine a fuel such as hydrogen and an oxidant such as oxygen to produce electricity. The oxygen is typically supplied by an air stream. The hydrogen and oxygen combine to result in the formation of water. Other fuels can be used such as natural gas, methanol, gasoline, and coal-derived synthetic fuels, for example.

The basic process employed by a fuel cell is efficient, substantially pollution-free, quiet, free from moving parts (other than an air compressor, cooling fans, pumps and actuators), and may be constructed to leave only heat and water as by-products. The term “fuel cell” is typically used to refer to either a single cell or a plurality of cells depending upon the context in which it is used. The plurality of cells is typically bundled together and arranged to form a stack with the plurality of cells commonly arranged in electrical series. Since single fuel cells can be assembled into stacks of varying sizes, systems can be designed to produce a desired energy output level providing flexibility of design for different applications.

Different fuel cell types can be provided such as phosphoric acid, alkaline, molten carbonate, solid oxide, and proton exchange membrane (PEM), for example. The basic components of a PEM-type fuel cell are two electrodes separated by a polymer membrane electrolyte. Each electrode is coated on one side with a thin catalyst layer. The electrodes, catalyst, and membrane together form a membrane electrode assembly (MEA).

As is known, hydrogen is supplied to the fuel cells in a fuel cell stack to cause the necessary chemical reaction to power the vehicle using electricity. However, the fuel cell system and stack require appropriate ventilation in the event of any hydrogen leaks from the fuel cell stack. Moreover, the fuel cell system must also be able to accurately detect any leakage of hydrogen from the fuel cell stack so that appropriate safety measures may be taken. Accordingly, there is a need for a robust fuel cell system which can provide appropriate ventilation and leak detection of the fuel cell stack at a lower cost with fewer parts.

### SUMMARY

In one embodiment of the present disclosure, a fuel cell system is provided which includes a fuel cell stack disposed within an enclosure, a compressor, an inlet air filter, an inlet passageway connecting the inlet air filter to an inlet of the compressor, a flow restrictor and a hydrogen sensor disposed along a ventilation line running from the enclosure back to the inlet passageway. The compressor further includes a compressor outlet in fluid communication with the fuel cell stack and a compressor inlet in fluid communication with the inlet air filter. The compressor may be configured to draw an ambient air stream through the inlet air filter towards the fuel cell stack thereby creating a vacuum in the inlet passageway. The flow restrictor is configured to couple the inlet passageway to the ventilation line running from the enclosure to the inlet passageway.

The enclosure may, but not necessarily, further define a ventilation aperture having a ventilation filter disposed proximate to the ventilation aperture. It is understood that the enclosure, may but not necessarily further define a BOP (balance of plant) enclosure and a fuel cell stack enclosure. The BOP enclosure may house some air management components as well as fuel management components for the fuel cell system. The fuel cell stack enclosure may include the fuel cell stack itself.

In the first embodiment, the ventilation line, the flow restrictor, and the hydrogen sensor may be in fluid communication with the BOP enclosure via a BOP ventilation line and are also in fluid communication with the fuel cell enclosure via a fuel cell ventilation line. The BOP ventilation line and the fuel cell ventilation line merge into one line which is the second portion of the ventilation line upstream of the flow restrictor and the hydrogen sensor. Moreover, the hydrogen sensor may be in communication with a fuel cell system controller operatively configured to provide driver alerts in the event the exhaust ventilation stream contains hydrogen levels which exceed a predetermined threshold. One example threshold may determine if a severe hydrogen leak is present such that the hydrogen levels exceed a relatively high value based on the hydrogen sensor data. Another example threshold may determine if a mild hydrogen leak is present such that the hydrogen levels exceed a relative low value based on hydrogen sensor data. In a non-limiting example of where a severe hydrogen leak is detected, the fuel cell system controller may, but not necessarily, shut down the entire fuel cell system. Similarly, in the non-limiting example where a mild hydrogen leak is detected, the fuel cell system controller, may but not necessarily, actuates a driver warning light such that the vehicle may be taken in for service.

The first embodiment may further include an enclosure exhaust passage configured to directly transfer a ventilation exhaust stream from the enclosure to the atmosphere and may further include an air flow meter disposed on the inlet passageway proximate to the inlet air filter. The air flow meter may be configured to determine whether the fuel cell system's ventilation is able to adequately draw in air.

In yet another embodiment of the present disclosure, a fuel cell system is provided which includes a fuel cell stack disposed in an enclosure, a compressor, an inlet passageway, a flow restrictor, a ventilation filter affixed to the flow restrictor and a hydrogen sensor disposed on a ventilation line. The compressor outlet may be in fluid communication with the fuel cell stack while the compressor inlet is in fluid communication with the inlet air filter via the inlet passageway. The compressor may therefore be configured to draw in an ambient air stream through the inlet air filter towards the fuel cell stack. As a result, a vacuum is created within the inlet passageway. The flow restrictor of may be configured to couple the inlet passageway to the ventilation line running from the enclosure to the inlet passageway while also controlling the air flow from the ventilation line to the inlet passageway.

In the second embodiment, the enclosure may, but not necessarily, further define a ventilation aperture or more than one ventilation aperture. Similarly, in the second embodiment, the enclosure, may but not necessarily further define a BOP (balance of plant) enclosure and a fuel cell stack enclosure. Where the enclosure further defines a BOP enclosure and a fuel cell stack enclosure. The BOP enclosure may house some air management components as well as fuel management components for the fuel cell system. The fuel cell stack enclosure may include the fuel cell stack itself.

In the second embodiment, the ventilation line, the flow restrictor, and the hydrogen sensor may be in fluid communication with the BOP enclosure via a BOP ventilation line. It is also understood that the ventilation line, the flow restrictor, and the hydrogen sensor may also be in fluid communication with the fuel cell enclosure via a fuel cell ventilation line. The BOP ventilation line and the fuel cell ventilation line may merge into one ventilation line which is the second portion of the ventilation line. The first portion of the ventilation line (having two lines—the BOP ventilation line and the fuel cell ventilation line) is upstream of the flow restrictor and the hydrogen sensor such that the single hydrogen sensor may determine if there are any hydrogen leaks in the entire fuel cell system via the second portion of the ventilation line. In this location, the hydrogen sensor may be in communication with a fuel cell system controller operatively configured to provide driver alerts in the event the exhaust ventilation stream contains hydrogen levels which exceed a predetermined threshold. The predetermined threshold may, but not necessarily, be one of a variety of thresholds as previously described.

Similar to the first embodiment, the second embodiment of the fuel cell system may further include an enclosure exhaust passage configured to directly transfer a ventilation exhaust stream from the enclosure to the atmosphere via enclosure exhaust outlet as well as an air flow meter disposed on the inlet passageway proximate to the inlet air filter where the air flow meter may be configured to determine whether the fuel cell system's ventilation is able to adequately draw in air.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is an example prior art view of a fuel cell system in a motor vehicle.

FIG. 2 is a first example, non-limiting embodiment of the fuel cell system of the present disclosure.

FIG. 3 is a second example, non-limiting embodiment of the fuel cell system of the present disclosure.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

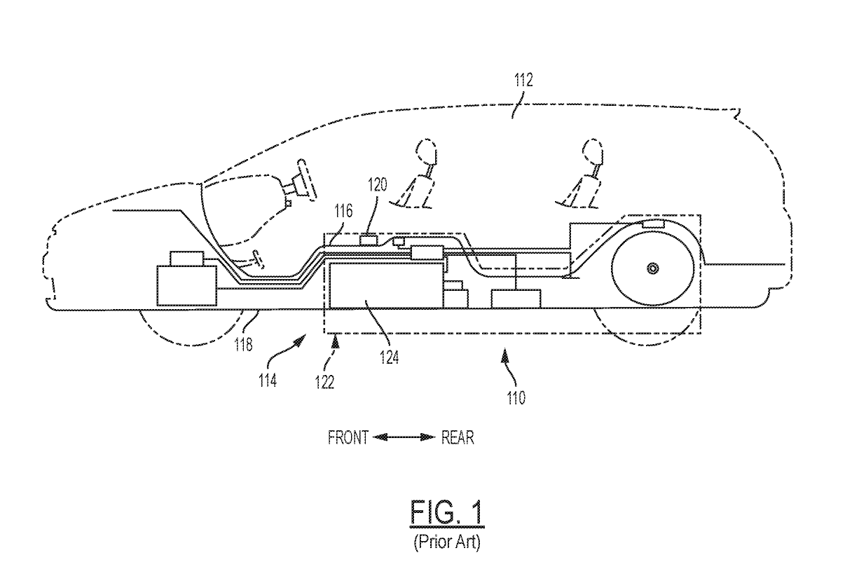

FIG. 1 shows an illustrative vehicle with a fuel cell system 10 known in the art. For simplicity, the fuel cell system 110 which powers the vehicle 112 may be disposed in the lower region 114 of the vehicle below the floor panel 116 and above the underbody panel 118. The fuel cell system 110 may be comprised of a hydrogen sensor 120 disposed within the hydrogen system unit 122 such that any hydrogen leaks are detected via the natural buoyancy and diffusivity of hydrogen gas within the hydrogen system unit. It is understood that the hydrogen system unit 122 contains at the very least the fuel cell stack 124.

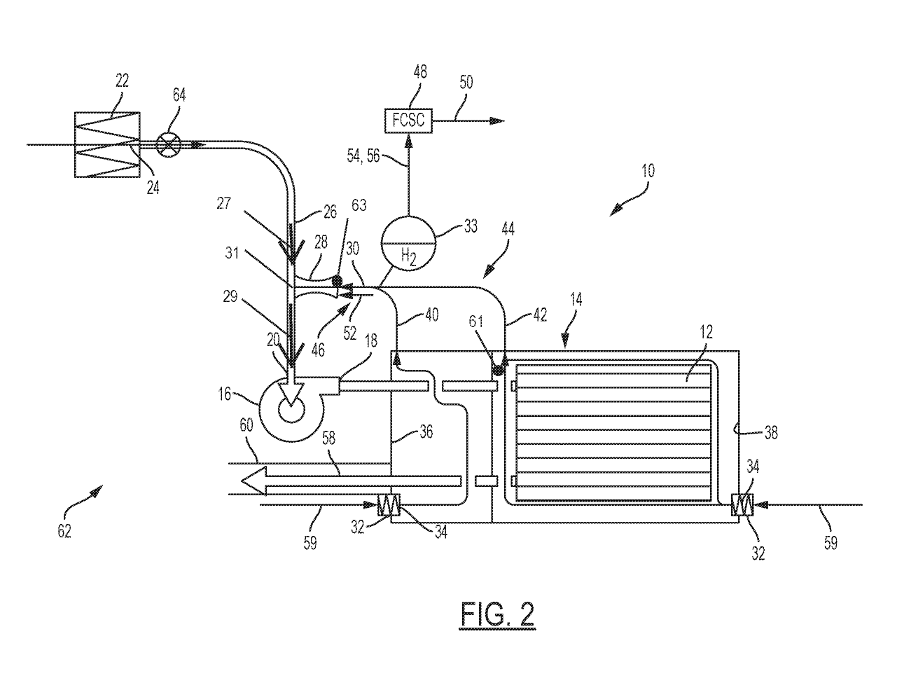

With reference to FIG. 2, the present disclosure therefore provides a fuel cell system 10 with an active ventilation system. This fuel cell system 10 includes a fuel cell stack 12 disposed within an enclosure 14, a compressor 16, inlet air filter 22, an inlet passageway 26 connecting the inlet air filter 22 to an inlet of the compressor 16, a flow restrictor 28 and a hydrogen sensor 33 disposed along a ventilation line 30 running from the enclosure 14 back to the inlet passageway 26. The compressor 16 further includes a compressor outlet 18 in fluid communication with the fuel cell stack 12 and a compressor inlet 20 in fluid communication with the inlet air filter 22. The compressor 16 may be configured to draw an ambient air stream 24 from a region 62 outside of the vehicle through the inlet air filter 22 towards the fuel cell stack 12 thereby creating a slight vacuum in the inlet passageway 26. The flow restrictor 28 is configured to couple the inlet passageway 26 to the ventilation line 30 running from the enclosure 14 to the inlet passageway 26.

Referring now to FIG. 2, the enclosure 14 may, but not necessarily, further define a ventilation aperture 32 having a ventilation filter 34 disposed proximate to the ventilation aperture 32. Fresh air 59 may flow into the enclosure via the ventilation aperture 32 as shown. It is understood that more than one ventilation aperture 32 may be defined in the enclosure 14 as shown in FIG. 2, and an associated ventilation filter 34 may disposed at each ventilation aperture 32 as shown. Ventilation filter 34′ may, but not necessarily, be a particulate filter and/or chemical filter of the type used in some fuel cell systems. Moreover, it is understood that the enclosure 14, may but not necessarily further define a BOP (balance of plant) enclosure 14 and a fuel cell stack enclosure 38. Where the enclosure 14 further defines a BOP enclosure 36 and a fuel cell stack enclosure 38. The BOP enclosure 36 may house some air management components as well as fuel management components for the fuel cell system 10. The fuel cell stack enclosure 38 may include the fuel cell stack 12 itself. Regardless, the enclosure 14 is configured to house components of the fuel cell system 10 where hydrogen is being used. The enclosure 14 therefore, in part, is configured to provide a physical boundary for most if not all of the hydrogen used in the fuel cell system 10.

As further illustrated in FIG. 2, the ventilation line 30, the flow restrictor 28, and the hydrogen sensor 33 are in fluid communication with the BOP enclosure 36 via a BOP ventilation line 40 and are also in fluid communication with the fuel cell enclosure 14 via a fuel cell ventilation line 42. The BOP ventilation line 40 and the fuel cell ventilation line 42 30 constitute a first portion 44 of the ventilation line 30. As shown, the BOP ventilation line 40 and the fuel cell ventilation line 42 merge into one line to form a second single portion of the ventilation line 30 upstream of the flow restrictor 28 and the hydrogen sensor 33. Accordingly, the single hydrogen sensor 33 may determine if there are any hydrogen leaks in the entire fuel cell system 10 via the ventilation line 30 which provides for more accurate leak detection at a lower cost with fewer components.

As further shown in FIG. 2, the hydrogen sensor 33 is in communication with a fuel cell system controller 48 operatively configured to provide driver alerts 50 in the event the exhaust ventilation stream 52 contains hydrogen levels which exceed a predetermined threshold. The predetermined threshold may be one of a variety of thresholds. One example threshold may determine if a severe hydrogen leak 54 is present such that the hydrogen levels exceed a relatively high value based on the hydrogen sensor 33 data. Another example threshold may determine if a mild hydrogen leak 56 is present such that the hydrogen levels exceed a relative low value based on hydrogen sensor 33 data. In a non-limiting example of where a severe hydrogen leak 54 is detected, the fuel cell system controller 48 may, but not necessarily, shut down the entire fuel cell system 10. Similarly, in the non-limiting example where a mild hydrogen leak 56 is detected, the fuel cell system controller 48, may but not necessarily, actuates a driver warning light such that the vehicle may be taken in for service.

Referring again to FIG. 2, the fuel cell system 10 of the present disclosure may further include an enclosure exhaust passage 60 configured to directly transfer a ventilation exhaust stream 58 from the enclosure 14 to the atmosphere 62 (or region 62 outside of the vehicle) and may further include an air flow meter 64 disposed on the inlet passageway 26 proximate to the inlet air filter 22. The air flow meter 64 may be configured to determine whether the fuel cell system 10's ventilation is able to adequately draw in air.

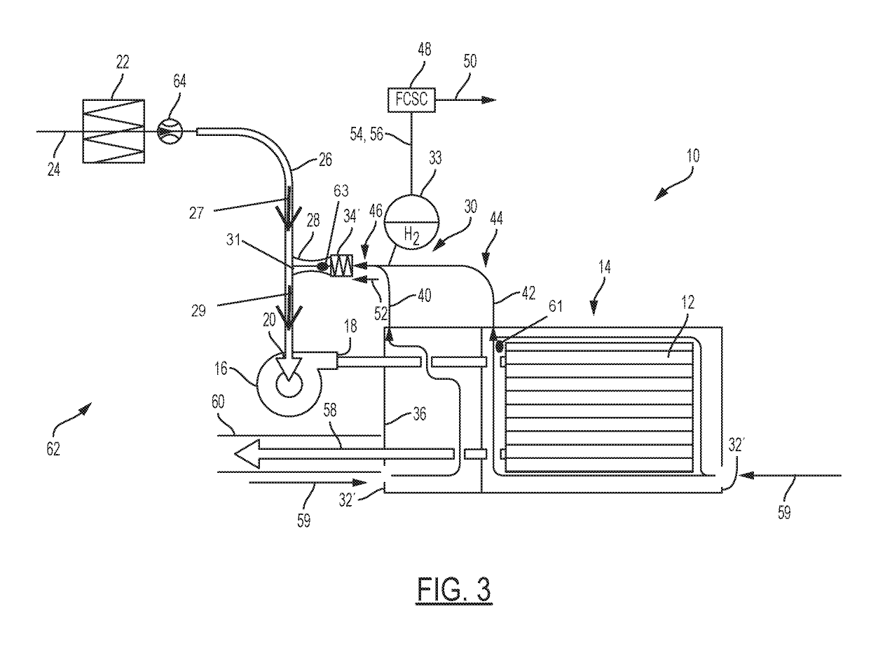

Referring now to FIG. 3, a second example non-limiting embodiment of the fuel cell system 10 of the present disclosure is shown. The fuel cell system 10 includes a fuel cell stack 12 disposed in an enclosure 14, a compressor 16, an inlet passageway 26, a flow restrictor 28, a ventilation filter 34′ affixed to ventilation line proximate to the flow restrictor 28 and the hydrogen sensor 33 which is also disposed on the second portion 46 of the ventilation line 30. As shown in FIG. 3, the compressor outlet 18 may be in fluid communication with the fuel cell stack 12 while the compressor inlet 20 is in fluid communication with the inlet air filter 22 via the inlet passageway 26. The compressor 16 may therefore be configured to draw in an ambient air stream through the inlet air filter 22 towards the fuel cell stack 12. As a result, a vacuum is created within the inlet passageway 26.

Also, the flow restrictor 28 of FIG. 3 may be configured to couple the inlet passageway 26 to the ventilation line 30 running from the enclosure 14 to the inlet passageway 26. In light of the vacuum which exists in the inlet passageway 26, the flow restrictor 28 therefore controls the flow from the ventilation line 30 to the inlet passageway 26 to an acceptable level. In this region of the ventilation line 30, the ventilation filter 34′ and the hydrogen sensor 33 are disposed proximate to the flow restrictor 28 such that the fuel cell system 10 could determine if there are any hydrogen leaks in the system via the hydrogen sensor 33. It is understood that ventilation filter 34′ may be a particulate filter and/or chemical filter of the type used in some fuel cell systems.

Referring again to FIG. 3, the enclosure 14 may, but not necessarily, further define a ventilation aperture 32. It is also understood that more than one ventilation aperture 32 may be defined in the enclosure 14 as shown in FIG. 3. Fresh air 59 may flow into the enclosure via the ventilation aperture 32 as shown. Moreover, it is understood that the enclosure 14, may but not necessarily further define a BOP (balance of plant) enclosure 14 and a fuel cell stack enclosure 38. Where the enclosure 14 further defines a BOP enclosure 36 and a fuel cell stack enclosure 38. The BOP enclosure 36 may house some air management components as well as fuel management components for the fuel cell system 10. The fuel cell stack enclosure 38 may include the fuel cell stack 12 itself. Regardless, the enclosure 14 is configured to house components of the fuel cell system 10 where hydrogen is being used. The enclosure 14 therefore, in part, is configured to provide a physical boundary for most if not all of the hydrogen used in the fuel cell system 10.

Furthermore, as shown in FIG. 3, the ventilation line 30, the flow restrictor 28, and the hydrogen sensor 33 are in fluid communication with the BOP enclosure 36 via a BOP ventilation line 40 30. It is also understood that the ventilation line 30, the flow restrictor 28, and the hydrogen sensor 33 are also in fluid communication with the fuel cell enclosure 14 via a fuel cell ventilation line 42. The BOP ventilation line 40 and the fuel cell ventilation line 42 constitute a first portion 44 of the ventilation line 30. As shown, the BOP ventilation line 40 and the fuel cell ventilation line 42 merge to form a second single portion of the ventilation line 30 upstream of the flow restrictor 28 and the hydrogen sensor 33. The single hydrogen sensor 33 may thus determine if there are any hydrogen leaks in the entire fuel cell system 10 via the second portion 46 of the ventilation line 30. This arrangement provides for more accurate leak detection at a lower cost with fewer components using only one hydrogen sensor 33.

As further shown in FIG. 3, the hydrogen sensor 33 may be in communication with a fuel cell system controller 48 operatively configured to provide driver alerts 50 in the event the exhaust ventilation stream 52 contains hydrogen levels which exceed a predetermined threshold. The predetermined threshold may be one of a variety of thresholds. One example threshold may determine if a severe hydrogen leak 54 is present such that the hydrogen levels exceed a relatively high value based on the hydrogen sensor 33 data. Another example threshold may determine if a mild hydrogen leak 56 is present such that the hydrogen levels exceed a relative low value based on hydrogen sensor 33 data. In a non-limiting example of where a severe hydrogen leak 54 is detected, the fuel cell system controller 48 may, but not necessarily, shut down the entire fuel cell system 10. Similarly, in the non-limiting example where a mild hydrogen leak 56 is detected, the fuel cell system controller 48, may but not necessarily, actuates a driver warning light such that the vehicle may be taken in for service.

Referring again to FIG. 3, the fuel cell system 10 of the present disclosure may further include an enclosure exhaust passage 60 configured to directly transfer a ventilation exhaust stream 58 from the enclosure 14 to the atmosphere via enclosure 14 exhaust outlet. The fuel cell system 10 of the present disclosure may further include an air flow meter 64 disposed on the inlet passageway 26 proximate to the inlet air filter 22. The air flow meter 64 may be configured to determine whether the fuel cell system's 10 ventilation is able to adequately draw in air.

It is understood with respect to all embodiments of the present disclosure, an air passageway 31 (see example of air passageway 31 in FIG. 3) is defined between the flow restrictor 28 and the inlet passageway 26. The sizing of the air passageway 31 between the flow restrictor 28 and the inlet passageway 26 (of FIGS. 2 and 3) should be sufficiently sized in all embodiments of the present disclosure to provide a vacuum condition where the ventilation air stream 52 in the ventilation line 30 (of FIGS. 2 and 3) is drawn into the inlet passageway 26 (of FIGS. 2 and 3) at a predetermined, desired flow rate such that the hydrogen sensor 33 could quickly detect any hydrogen leaks (represented by example element 61 in FIG. 3) or excessive levels of hydrogen in the air stream 52 (coming from the fuel cell stack 12). It is understood that the predetermined, desired flow rate for the ventilation air stream 52 at the interface/opening 31 between the flow restrictor 28 and the inlet passageway 26 for all embodiments may also be dictated by the required dilution levels of hydrogen within the air stream 52. For example, where a fuel cell system sized for 80 kW has an allowable permeation of hydrogen at 0.1 SLPM and where the hydrogen sensor is able to detect safe (non-flammable) concentrations of hydrogen at about 1% (well below the LEL of hydrogen in air), then the flow rate for the ventilation air stream 52 should be approximately equal to 100 times the allowable leak rate. Thus, in this case, 100×0.1 SLPM or about 10 SLPM. Appropriate dilution of hydrogen in the air stream is needed in order to avoid a false leak signal caused by the natural permeation of hydrogen (from the fuel cell stack or other hydrogen-containing fuel cell system components within the enclosure(s)) through any seals into the enclosures (such as the ventilation line 30).

Additionally, the flow rate of the ventilation air stream 52 entering the inlet air passageway 26 from the ventilation line 30 must not disrupt the overall air flow control of the fuel cell system 10 given that the air stream 52 enters the inlet air passageway 26 downstream of the inlet air flow meter 64. However, it is also understood that an additional air flow meter (not shown) may be installed onto the inlet air passageway 26 downstream of the flow restrictor 28 to detect any such undesired disruptions to the air stream which is entering the compressor 16. Since the safe (non-flammable) flow is 10 SLPM and the total airflow for a non-limiting example fuel cell system sized for about 80 kW is about 3700 SLPM at full power. This is the approximate air flow needed for the cathode of the fuel cell stack to provide adequate oxygen to support the electrochemical reactions therein. The flow rate of air stream 52 which enters inlet air passageway 26 must be relatively insignificant relative to the flow rate for inlet air stream 27 such that the flow rate for the combined air streams 29—inlet air stream 27 and ventilation air stream 52 stays within an acceptable deviation range with respect to air flow measurements taken upstream at the inlet air flow meter 62. Accordingly, to the extent that readings from inlet air flow meter 62 have any small errors, such errors could be attributed to flow rate change due to the ventilation air stream 52 which enters inlet passageway 26. Moreover, it is also understood that small errors in the data from the inlet air flow meter 62 could also be attributed to any clogging at the inlet air filter 22 as well. Additionally the high dilution of the ventilation air stream 52 upon its mixture into the inlet airstream 27 such that combined air stream 29 (see non-limiting example in FIG. 3) at the compressor inlet 29 can therefore safely dilute much higher hydrogen leak rates that may come from severe seal failures (resulting in very high hydrogen concentrations in the ventilation stream 52). This type of event could be accompanied by an emergency shut down of the fuel cell system prompted by the hydrogen sensor 33 in the ventilation line 30 or other fuel cell system diagnostics for hydrogen leaks.

It is further understood that any hydrogen (represented by example element 63 in FIG. 3) that is in the ventilation air stream 52 in FIGS. 2 and 3 is safely recirculated through the compressor 16 back to the fuel cell stack 12 such that the hydrogen reacts with oxygen on the catalyst within the cathode electrode of the fuel cell stack 12 enabling safe consumption of hydrogen that may leak from components within the enclosure(s) of the fuel cell system. It is understood that the resulting heat created by the hydrogen reaction at the catalyst is carried away in the stack coolant (not shown).

While at least two exemplary embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A fuel cell system comprising:
a fuel cell stack disposed in an enclosure;
a compressor having a compressor outlet in fluid communication with the fuel cell stack and a compressor inlet in fluid communication with an inlet air filter, the compressor being configured to draw an ambient air stream through the inlet air filter towards the fuel cell stack;
an inlet passageway connecting the inlet air filter to an inlet of the compressor;
a flow restrictor coupling the inlet passageway to a ventilation line running from the enclosure to the inlet passageway; and
a hydrogen sensor disposed along the ventilation line proximate to the flow restrictor.

2. The fuel cell system as defined in claim 1 wherein the enclosure further defines a ventilation aperture having a ventilation filter disposed proximate to the ventilation aperture.

3. The fuel cell system as defined in claim 2 wherein the enclosure further defines a BOP enclosure and a fuel stack enclosure.

4. The fuel cell system as defined in claim 3 where in the ventilation line, the flow restrictor, and the hydrogen sensor are in fluid communication with the BOP enclosure via a BOP ventilation line and are also in fluid communication with the fuel cell enclosure via a fuel cell ventilation line.

5. The fuel cell system as defined in claim 4 wherein the BOP ventilation line and the fuel cell ventilation line merge to form a second portion of the ventilation line upstream of the flow restrictor and the hydrogen sensor.

6. The fuel cell system as defined in claim 5 wherein the hydrogen sensor is in communication with a fuel cell system controller operatively configured to provide driver alerts in the event of an exhaust ventilation stream contains hydrogen levels which exceed a predetermined threshold.

7. The fuel cell system as defined in claim 6 wherein the fuel cell system controller shuts down the fuel cell system when the hydrogen sensor detects a severe hydrogen leak.

8. The fuel cell system as defined in claim 6 wherein the fuel cell system controller actuates a driver warning light when the hydrogen sensor detects a mild hydrogen leak.

9. The fuel cell system as defined in claim 6 wherein further comprising an enclosure exhaust passage configured to directly transfer a ventilation exhaust stream from the enclosure to the atmosphere.

10. The fuel cell system as defined in claim 9 further comprising an air flow meter disposed on the inlet passageway proximate to the inlet air filter.

11. A fuel cell system comprising:
a fuel cell stack disposed in an enclosure;
a compressor in fluid communication with the fuel cell stack and an inlet air filter, the compressor being configured to draw an ambient air stream through the inlet air filter towards the fuel cell stack;
an inlet passageway connecting the inlet air filter to an inlet of the compressor;
a flow restrictor coupling the inlet passageway to a ventilation line running from the enclosure to the inlet passageway; and
a ventilation filter and a hydrogen sensor disposed along the ventilation line proximate to the flow restrictor.

12. The fuel cell system as defined in claim 11 wherein the enclosure further defines a ventilation aperture.

13. The fuel cell system as defined in claim 11 wherein the enclosure further defines a BOP enclosure and a fuel stack enclosure.

14. The fuel cell system as defined in claim 13 where in the ventilation line, the flow restrictor, and the hydrogen sensor are in fluid communication with the BOP enclosure via a BOP ventilation line and are also in fluid communication with the fuel cell enclosure via a fuel cell ventilation line.

15. The fuel cell system as defined in claim 14 wherein the BOP ventilation line and the fuel cell ventilation line merge to form a second portion of the ventilation line upstream of the flow restrictor and the hydrogen sensor.

16. The fuel cell system as defined in claim 15 wherein the hydrogen sensor is in communication with a fuel cell system controller operatively configured to provide driver alerts in the event an exhaust ventilation stream contains hydrogen levels which exceed a predetermined threshold.

17. The fuel cell system as defined in claim 16 wherein the fuel cell system controller shuts down the fuel cell system when the hydrogen sensor detects a severe hydrogen leak.

18. The fuel cell system as defined in claim 16 wherein the fuel cell system controller actuates a driver warning light when the hydrogen sensor detects a mild hydrogen leak.

19. The fuel cell system as defined in claim 16 wherein further comprising an enclosure exhaust passage configured to directly transfer a ventilation exhaust stream from the enclosure to a region outside of the vehicle.

20. The fuel cell system as defined in claim 19 further comprising an air flow meter disposed on the inlet passageway proximate to the inlet air filter.
